(19) United States
(12) Patent Application Publication
(10) Pub. No.: US 2010/0147117 A1
(43) Pub. Date: Jun. 17, 2010

(54) CONNECTION DEVICE FOR LATCHING AND RELEASING A SOCKET

(76) Inventor: Chih-Ching HSIEH, Feng Yuan (TW)

Correspondence Address: SINORICA, LLC, 2275 Research Blvd., Suite 500, ROCKVILLE, MD, 20850, US

(21) Appl. No.: 12/335,751

(22) Filed: Dec. 16, 2008

(51) Int. Cl. B25B 23/16; B25G 3/12

(52) U.S. Cl. 81/177.85; 403/322.1

(57) ABSTRACT

A connection device for connecting with a socket includes a main body formed with an internal axial slide passage. A slide rod is mounted in the slide passage and slidable along the slide passage. An engaging column is mounted in a through hole of the main body. A contact face is formed at a bottom end of the engaging column in contact with a slope of one end of the slide rod. In normal state, the slide rod is urged by a resilient member, whereby the slope approaches and pushes the engaging column outward. The engaging column and the slide rod are face-to-face in contact with each other. A socket can be directly fitted onto the main body of the connection device without first making the slide rod leave the engaging column. When the socket touches the engaging column, the action force is transferred to the slide rod to make the slope thereof move away from the engaging column.

### FIELD OF THE INVENTION

The present invention is generally related to a hand tool, and more particularly to a connection device for connecting with a socket.

### BACKGROUND OF THE INVENTION

U.S. Pat. Nos. 6,006,632 and 6,003,414 of this applicant disclose conventional socket connection devices. The socket connection device includes a connecting rod having an insertion end for connecting with a socket by means of insertion. The connecting rod is formed with an internal axial slide passage. A slide rod is disposed on the slide passage and slidable along the slide passage. The insertion end of the connecting rod is formed with a radial through hole in communication with the slide passage. A steel ball is received in the through hole. The slide rod has a slope corresponding to the steel ball. In normal state, a resilient member urges the slide rod to push the steel ball outward, whereby the steel ball partially protrudes out of the through hole.

When connecting a socket with the connection device, a user needs to first press or pull the slide rod to drop the steel ball to the bottom end of the slope without protruding from the connecting rod. Thereafter, the insertion end of the connecting rod can be inserted into a fitting hole of the socket. Then the slide rod is released from the pressing or pulling force and the resilient member pushes the slide rod back to its home position. At this time, the slope of the slide rod again pushes the steel ball outward, whereby the steel ball again partially protrudes out of the through hole to engage with a wall of the fitting hole of the socket. Under such circumstance, the socket is connected with the connection device without detachment.

When releasing the socket, the user needs to again press or pull the slide rod away from the steel ball, permitting the steel ball to move into the connecting rod without engaging with the socket. Under such circumstance, the socket can be taken off.

The conventional connection device is able to engage with the socket and release the socket. However, no matter when connecting the socket with the connection device or disconnecting the socket therefrom, a user needs to perform a pressing or pulling operation. This is inconvenient in use of the connection device.

It is impossible to forcedly insert the insertion end of the connecting rod into the fitting hole of the socket without pressing or pulling the slide rod. The steel ball and the slope of the slide rod are point-to-point in contact with each other by small contact area. Therefore, the action force is concentrated to the point and it is hard to push and slide the slide rod via the steel ball.

### SUMMARY OF THE INVENTION

It is therefore a primary object of the present invention to provide a connection device for connecting with a socket. The socket can be directly connected with the connection device without any pressing or pulling operation.

According to the above object, the connection device of the present invention includes: a main body having a front end as an insertion end; a slide rod mounted in an axial slide passage of the main body and slidable along the slide passage; a slope being formed on a front end of the slide rod; and an engaging column mounted in a through hole formed on a circumference of the main body. A contact face is formed at a bottom end of the engaging column. The contact face snugly attaches to the slope of the slide rod. In normal state, the slide rod is resiliently urged by a resilient member, whereby the slope approaches and pushes the engaging column outward to protrude a top end of the engaging column out of the main body.

The engaging column and the slide rod are face-to-face in contact with each other. When the socket is fitted onto the main body to touch the engaging column, the action force is effectively transferred from the engaging column to the slide rod to make the slope thereof move away from the engaging column. At this time, the top end of the engaging column can be moved into the main body to complete connection of the socket with the connection device.

The present invention can be best understood through the following description and accompanying drawings wherein:

### BRIEF DESCRIPTION OF THE DRAWINGS

FIG. 1 is a side view of a first embodiment of the present invention;

FIG. 2 is a longitudinally sectional view according to FIG. 1;

FIGS. 3A to 3D respectively show different types of engaging columns of the present invention;

FIGS. 4 and 5 are sectional views showing the connection of a socket with the present invention;

FIG. 6 is a sectional view showing the disconnection of the socket from the present invention;

FIG. 7 is a partially sectional view of a second embodiment of the present invention;

FIG. 8 is a partially sectional view according to FIG. 7, showing the operation of FIG. 7;

FIG. 9 is a partially sectional view of a third embodiment of the present invention;

FIG. 10 is a longitudinally sectional view of a fourth embodiment of the present invention;

FIG. 11 is a longitudinally sectional view according to FIG. 10, showing the operation of the FIG. 10; and

FIGS. 12A to 12D respectively show different types of engaging columns usable in the fourth embodiment of the present invention.

### DETAILED DESCRIPTION OF THE PREFERRED EMBODIMENTS

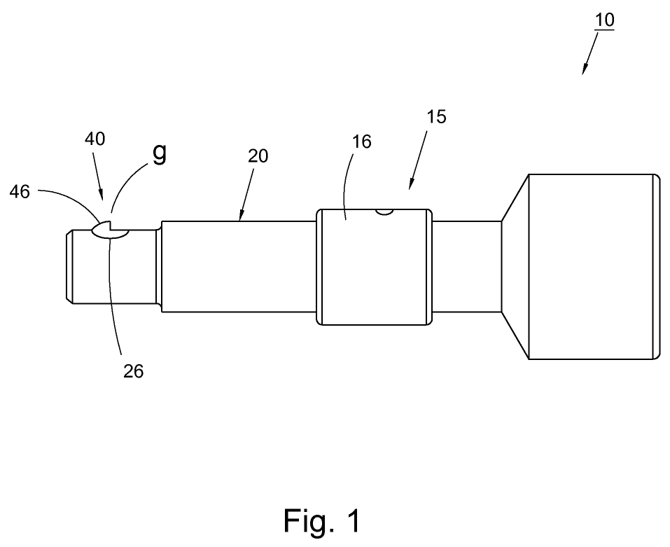

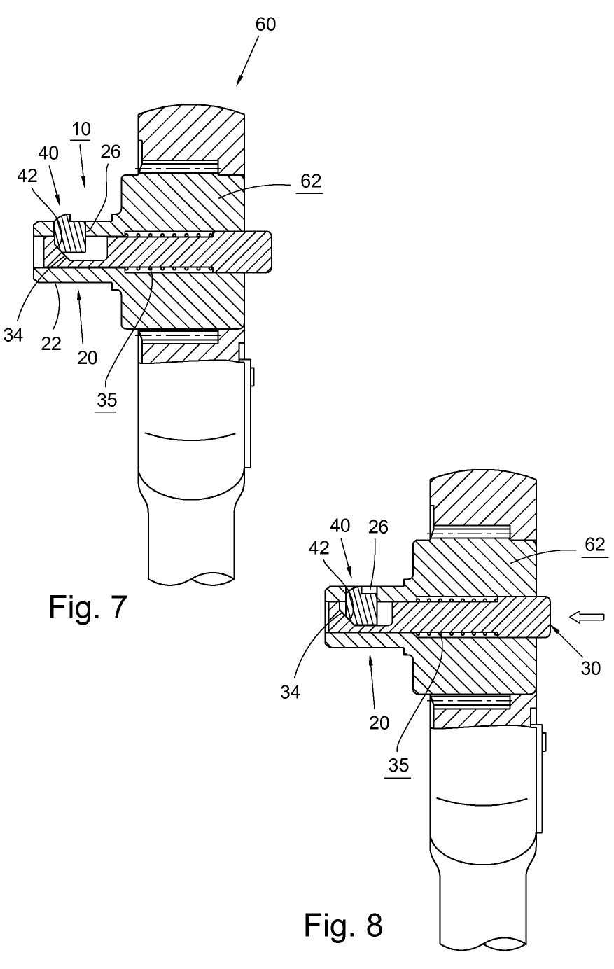

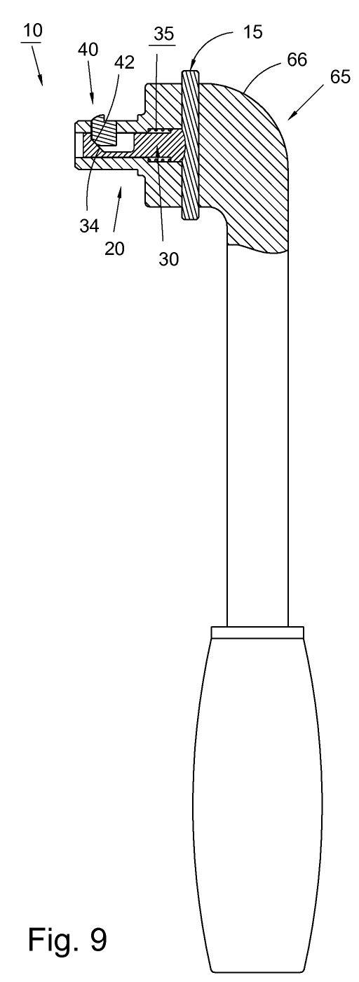

Please refer to FIG. 1. The connection device 10 of the present invention can be independently used as a connection rod. Alternatively, as shown in FIG. 7, the connection device 10 can be applied to a ratchet wrench 60 as an internal structure of the ratchet 62. Still alternatively, as shown in FIG. 9, the connection device 10 can be applied to a socket wrench 65 as an internal structure thereof.

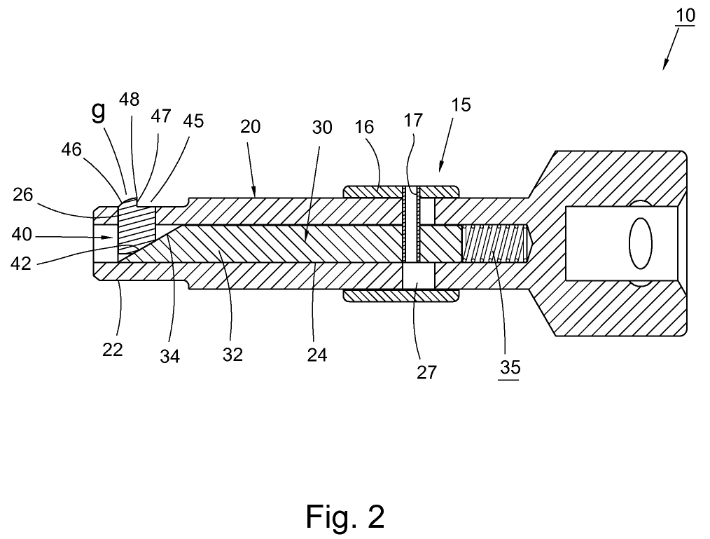

As exemplified with the connection device 10 shown in FIGS. 1 and 2, the connection device 10 includes a main body 20. The main body 20 has a front end as an insertion end 22. The main body 20 is formed with an internal axial slide passage 24. A through hole 26 is formed on a circumference of the insertion end 22 in communication with the slide passage 24. In this embodiment, the through hole 26 is formed on the insertion end 22 in a radial direction of the main body 20. That is, an axis of the through hole is substantially perpendicular to an axis of the slide passage 24.

A slide rod 30 mounted in the slide passage 24 of the main body 20 and slidable along the slide passage. The slide rod 30 has a front end as a driving end 32. A slope 34 is formed on the driving end corresponding to the through hole 26. A resilient member 35 is disposed in the main body 20. One end of the resilient member 35 abuts against a rear end of the slide rod. When free from any external force, the resilient member 35 keeps the slide rod moving to an engaging position where the slope 34 is moving toward the through hole 26. In this embodiment, the slide rod 30 tends to move toward the insertion end 22.

A user can operate and move the slide rod 30 to a releasing position. For example, the connection device 10 has a linking mechanism 15. The linking mechanism 15 includes a pull collar 16 fitted on an outer circumference of the main body 20 and a pin 17. A first end of the pin 17 is inserted in the pull collar 16. A second end of the pin 17 extends into a cavity 27 of the main body and is inserted in the slide rod 30. When pulling the pull collar 16 backward, the slide rod is driven and moved backward.

The connection device 10 further includes an engaging column 40. The engaging column 40 is a column body such as a cylinder or a polygonal prism. A contact face 42, which is a slope in this embodiment, is formed at a bottom end (rear side) of the engaging column. The engaging column 40 is mounted in the through hole 26 of the main body 20 and is displaceable along the through hole 26. The contact face 42 of the bottom end of the engaging column snugly attaches to and contacts with the slope 34 of the slide rod 30. A rear section of top end of the engaging column 40 is cut off to form a recess 45. Accordingly, relative to the rear section, a front section (g) of the top end of the engaging column protrudes upward. A front edge of the top end of the engaging column is a pressed face 46 gradually uprising from a front side to a rear side. Preferably, the pressed face 46 is an arced face or a slope. Also, a rear side of the front section (g) is formed as a sidewall 47. The sidewall and the pressed face 46 contain an angle 48. In normal state, the slide rod 30 pushes the engaging column 40 outward to protrude the top end of the engaging column out of the main body.

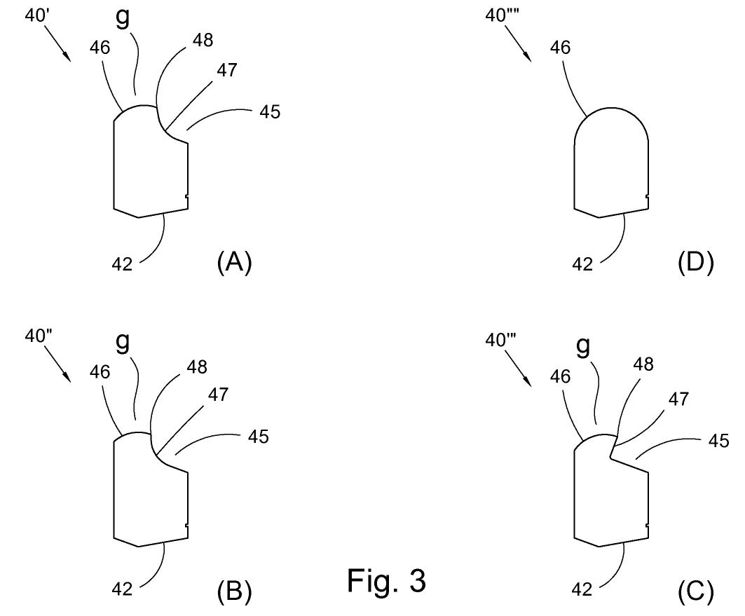

FIGS. 3A to 3D respectively show some other engaging columns 40′ to 40″″ in different aspects of the present invention. The bottom end of each of the engaging columns is formed with an inclined contact face 42. The front edge of the top end of each of the engaging columns has a pressed face 46. A rear section of each of the engaging columns 40′, 40″, 40′″ is formed with a recess 45. A rear side of the front section (g) of each of the engaging columns 40′, 40″, 40′″ is formed with a sidewall 47 and an angle 48. The engaging column 40″″ has a domed top end without any recess. The front edge of the top end of the engaging column 40″″ also has a pressed face 46.

Besides, a second resilient member can be arranged between the main body and the engaging column. The second resilient member resiliently abuts against the engaging column, whereby the engaging column tends to move inward. It should be noted that the resilience of the second resilient member is such that the second resilient member will not hinder the resilient member 35 from pushing the slide rod.

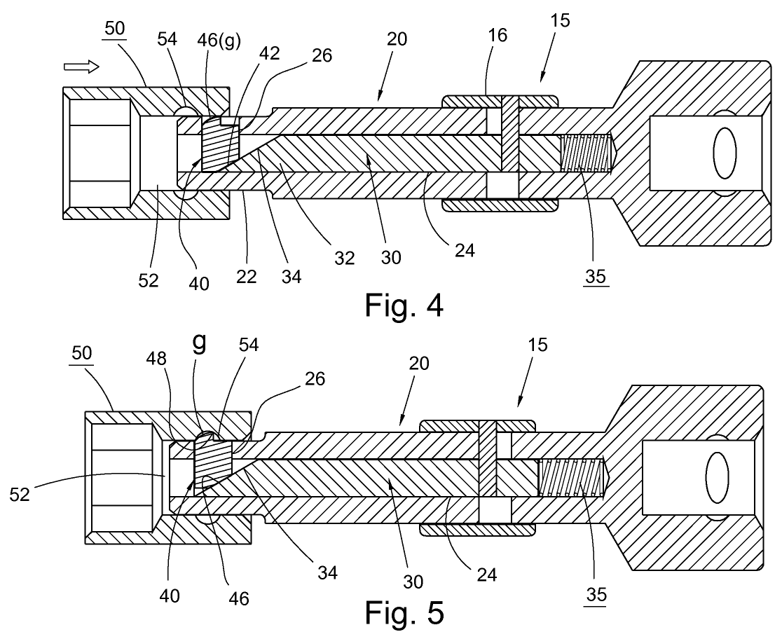

Referring to FIG. 4, when connecting the connection device 10 with a socket, the socket 50 is forcedly pushed and fitted onto the insertion end 22 of the main body 20. After the socket touches the pressed face 46 of the engaging column 40, a component force of the action force of the socket pushes the engaging column to move toward the interior of the main body 20. The contact face 42 of the engaging column 40 and the slope 34 of the slide rod 30 are face-to-face in contact with each other by large forced area. Therefore, the action force can be effectively transferred to the slide rod 40. Accordingly, when the engaging column is moved inward, the slide rod 40 is pushed by the engaging column and moved toward the releasing position. At this time, the slope 34 gradually leaves the engaging column and the top end of the engaging column is moved into the main body.

When the socket is further pushed to move a dent 54 formed on a wall of a fitting hole 52 of the socket to a position above the engaging column 40, the engaging column is released from the press of the socket. Under such circumstance, the resilient member 35 pushes the slide rod 30 and makes the slope 34 approach the engaging column. At this time, the engaging column is pushed upward and the top end of the engaging column extends into the dent 54 of the socket to latch the socket as shown in FIG. 5. When the socket is latched, the sidewall 47 of the angle 48 of the top end of the engaging column 40 abuts against a wall of the dent 54 to effectively avoid detachment of the socket.

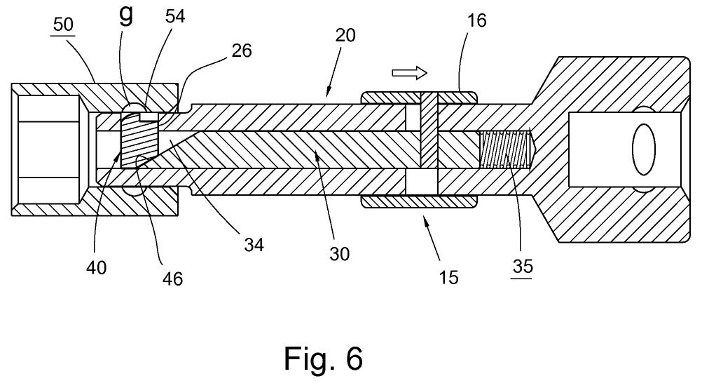

When it is desired to take off the socket, a user must pull the pull collar 16 backward to drive the slide rod 30 to the releasing position as shown in FIG. 6. At this time, the slope 34 is moved away from the engaging column 40, permitting the engaging column to descend from an upper side of the slope 34 to a lower side thereof. Under such circumstance, the top end of the engaging column is moved into the main body and unlatched from the dent 54 of the socket 50. In this case, the socket can be separated from the connection device 10. After the pull collar 16 is released from the pulling force, the slide rod is resiliently pushed by the resilient member 35 back to the engaging position. At this time, the engaging column is again pushed outward.

In use of the present invention, a user only needs to fit the socket onto the connection device to latch the connection with the socket. Accordingly, the socket can be connected with the connection device in a simple manner without any other operation step (such as pulling the linking mechanism 15). When taking off the socket, the user needs to perform an operation step, that is, pulling the linking mechanism, to separate the socket 50 from the connection device 10.

FIGS. 7 to 9 show a second embodiment and a third embodiment of the connection device of the present invention respectively. The same components are denoted by the same reference numerals as the first embodiment.

In the second embodiment as shown in FIG. 7, the main body 20 is integrally formed with the ratchet 62. The bottom end (front side) of the engaging column 40 has a contact face 42 in contact with the slope 34 of the slide rod 30. In normal state, the slide rod 30 is pushed by the resilient member 35 and positioned in the engaging position. The top end of the engaging column 40 protrudes out of the main body. When fitting a socket onto the insertion end 22 of the main body, the socket can directly urge the engaging column 40 to move inward for latching with the socket. The operation is identical to that of the first embodiment.

When releasing the socket, as shown in FIG. 8, the slide rod 30 is pressed and moved forward to the releasing position, the slope 34 is moved away from the engaging column 40 and the top end of the engaging column is moved into the through hole 26.

FIG. 9 shows a third embodiment of the present invention, in which the main body 20 is integrally formed with a head section 66 of a wrench 65. The socket is latched in the same manner as the first embodiment. When releasing the socket, by means of pushing a linking mechanism 15 (a push rod), the slide rod 30 is moved forward to the releasing position. At this time, the top end of the engaging column 40 is moved into the main body. The linking mechanism 15 and slide rod 30 of this embodiment can be applied to the main body of the first embodiment to form another embodiment.

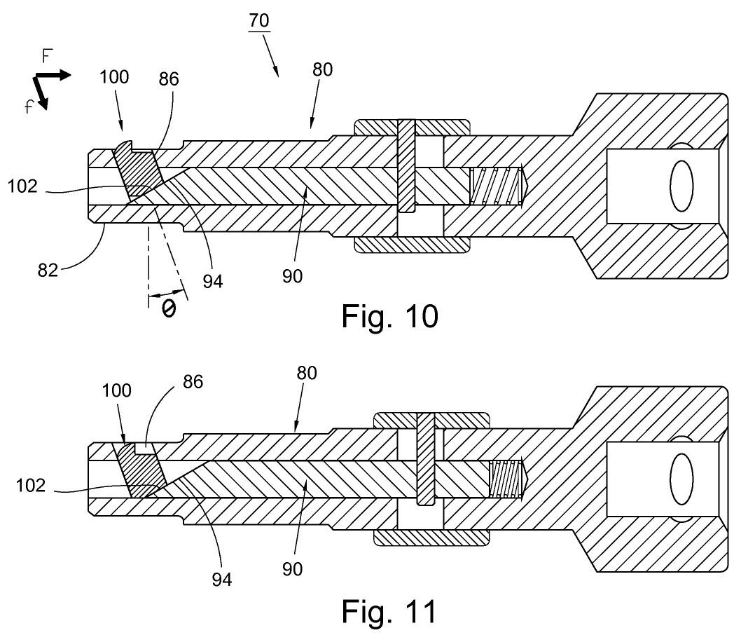

FIGS. 10 and 11 show a fourth embodiment of the connection device 70 of the present invention, which has a structure substantially identical to that of any of the above embodiments. The contact face 102 of the engaging column 100 contacts the slope 94 of the slide rod 90. In FIG. 10, the slide rod 90 is positioned in the engaging position and the top end of the engaging column 100 protrudes out of the main body 80. In FIG. 11, the slide rod is positioned in the releasing position and the top end of the engaging column 100 is moved into the through hole 86. In this embodiment, the through hole 86 is an oblique hole. The axial direction of the through hole 86 and the radial direction of the main body contain an angle θ such as 15 to 35 degrees. The engaging column is obliquely displaceable along the through hole 86.

When a socket is fitted onto the insertion end 82 of the main body 80, the action force (F) of the socket acts on the engaging column 100. In this state, a component force (f) of the action force pushes the engaging column 100 inward. The direction of the component force (f) is approximately or exactly the same as the axial direction of the through hole 86. Accordingly, the engaging column 100 can be more easily pushed and displaced to facilitate operation. Similarly, the slide rod 90 can push the engaging column 100 outward with less force.

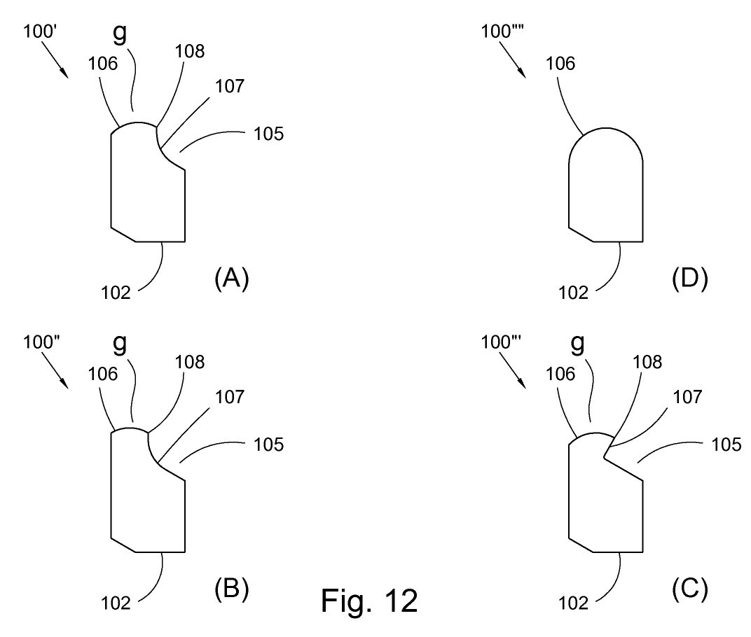

FIGS. 12A to 12D respectively show some other aspects of engaging columns 100′ to 100″″ usable in this embodiment. The bottom end of each of the engaging columns is formed with a contact face 102. The front edge of the top end of each of the engaging columns has a pressed face 106. A rear section of each of the engaging columns 100′, 100″, 100′″ is formed with a recess 105. A rear side of the front section (g) of each of the engaging columns 100′, 100″, 100′″ is formed with a sidewall 107 and an angle 108. The contact face 102 can be a slope or a plane face normal to the axial direction of the engaging column. No matter whether the contact face 102 is a slope or a plane face, when the engaging column is received in the through hole 86, the contact face is inclined and snugly attached to the slope of the slide rod. The engaging columns shown in FIG. 3 are also usable in this embodiment.

According to the present invention, the socket can be directly connected and latched with the connection device simply by means of insertion without any other operation step. Therefore, the use of the connection device is facilitated.

The above embodiments are only used to illustrate the present invention, not intended to limit the scope thereof. Many modifications of the above embodiments can be made without departing from the spirit of the present invention.

What is claimed is:

1. A connection device for latching and releasing a socket, comprising:
a main body having a front end as an insertion end, the main body being formed with an internal axial slide passage; a through hole being formed on a circumference of the insertion end in communication with the slide passage;
a slide rod mounted in the slide passage of the main body and slidable along the slide passage between an engaging position and a releasing position; a slope being formed on a front end of the slide rod corresponding to the through hole;
an engaging column, which is a column body mounted in the through hole of the main body and displaceable along the through hole; a contact face being formed at a bottom end of the engaging column, the contact face snugly attaching to the slope of the slide rod; a pressed face being formed at a top end of the engaging column, the pressed face gradually uprising from a front side to a rear side; and
a resilient member disposed in the main body, the resilient member serving to resiliently abut against the slide rod and urge the slide rod to move toward the engaging position, whereby the slope approaches the engaging column to push the engaging column outward and make the top end of the engaging column protrude out of the main body; when the slide rod is displaced toward the releasing position, the slope being moved away from the engaging column and the top end of the engaging column being moved into the main body.

2. The connection device as claimed in claim 1, wherein a rear section of the top end of the engaging column is formed with a recess, whereby the top end of the engaging column has an upward protruding front section; the pressed face being formed on top face of the front section.

3. The connection device as claimed in claim 2, wherein a rear side of the front section is formed with a sidewall, the sidewall and the pressed face containing an angle.

4. The connection device as claimed in claim 1, wherein an axial direction of the through hole is substantially parallel to a radial direction of the main body.

5. The connection device as claimed in claim 2, wherein an axial direction of the through hole is substantially parallel to a radial direction of the main body.

6. The connection device as claimed in claim 3, wherein an axial direction of the through hole is substantially parallel to a radial direction of the main body.

7. The connection device as claimed in claim 4, wherein the contact face of the engaging column is a slope.

8. The connection device as claimed in claim 5, wherein the contact face of the engaging column is a slope.

9. The connection device as claimed in claim 6, wherein the contact face of the engaging column is a slope.

10. The connection device as claimed in claim 1, wherein the through hole is an oblique hole, an axial direction of the through hole and a radial direction of the main body containing an angle.

11. The connection device as claimed in claim 2, wherein the through hole is an oblique hole, an axial direction of the through hole and a radial direction of the main body containing an angle.

12. The connection device as claimed in claim 3, wherein the through hole is an oblique hole, an axial direction of the through hole and a radial direction of the main body containing an angle.

13. The connection device as claimed in claim 10, wherein the contact face of the engaging column is a slope.

14. The connection device as claimed in claim 11, wherein the contact face of the engaging column is a slope.

15. The connection device as claimed in claim 12, wherein the contact face of the engaging column is a slope.

16. The connection device as claimed in claim 10, wherein the contact face of the engaging column is a plane face normal to the axial direction of the engaging column.

17. The connection device as claimed in claim 11, wherein the contact face of the engaging column is a plane face normal to the axial direction of the engaging column.

18. The connection device as claimed in claim 12, wherein the contact face of the engaging column is a plane face normal to the axial direction of the engaging column.

19. The connection device as claimed in claim 1, wherein a rear end of the slide rod protrudes out of the main body, whereby by means of pressing the rear end of the slide rod, the slide rod can be displaced to the releasing position.

20. The connection device as claimed in claim 1, further comprising a linking mechanism substantially connected with the slide rod, whereby by means of operating the linking mechanism, the slide rod can be driven and moved to the releasing position.
